(19) United States
(12) Patent Application Publication
(10) Pub. No.: US 2024/0131475 A1
(43) Pub. Date: Apr. 25, 2024

(54) POLYMERIC MATERIALS AND METHODS FOR SELECTIVE ION SEPARATION OR TRANSPORT

(71) Applicants: ENERGY EXPLORATION TECHNOLOGIES, INC., Austin, TX (US); BOARD OF REGENTS, THE UNIVERSITY OF TEXAS SYSTEM, Austin, TX (US)

(72) Inventors: Kevin Kruschka REIMUND, Austin, TX (US); Richelle LYNDON, Austin, TX (US); Amit PATWARDHAN, Austin, TX (US); Teague EGAN, Austin, TX (US); Benny Dean FREEMAN, Austin, TX (US)

(73) Assignees: ENERGY EXPLORATION TECHNOLOGIES, INC., Austin, TX (US); BOARD OF REGENTS, THE UNIVERSITY OF TEXAS SYSTEM, Austin, TX (US)

(21) Appl. No.: 18/546,318

(22) PCT Filed: Feb. 16, 2022
(86) PCT No.: PCT/US2022/016611

§ 371 Date: Aug. 13, 2023

Related U.S. Application Data
(60) Provisional application No. 63/149,881, filed on Feb. 16, 2021.

(51) Int. Cl. B01D 69/02; B01D 61/44; B01D 71/16; C08J 5/18

(52) U.S. Cl. CPC B01D 69/02; B01D 61/44; B01D 71/16; C08J 5/18; B01D 2325/04; B01D 2325/20; B01D 2325/32; C08J 2301/12

(57) ABSTRACT

Membrane materials and methods are disclosed for selectively separating or transporting ions in liquid media. In embodiments, the membranes comprise cellulose acetate polymer films having high cation, monovalent/divalent, and/or Li⁺/Mg²⁺ selectivity. Systems and methods for use of such membranes, including the direct extraction of lithium (DLE) from natural brines and other resources, also are disclosed.

This application claims the benefit of priority to U.S. Provisional Application No. 63/149,881, filed on Feb. 16, 2021, the entire contents of which are hereby incorporated by reference.

### STATEMENT OF GOVERNMENT SUPPORT

This invention was made with government support under Grant no. DE-SC0019272 awarded by the Department of Energy. The government has certain rights in the invention.

### BACKGROUND

Advances in secondary battery technology employing lithium as the charge carrier have resulted in an explosion in battery usage in consumer products ranging from: cell phones, earphones, watches, hand tools, and lawn mowers, to large-scale applications such as grid energy storage, electrically powered trucks and cars, and even electrically powered airplanes. As a result, the demand for lithium extraction has grown dramatically and is predicted to continue to increase in the coming decades. Lithium is principally produced via two methods: the leaching of lithium from Li-containing minerals such as pegmatite (i.e., “hard-rock mining”), and the selective enrichment of lithium from Li-containing brine resources (i.e., “brine extraction”). In general, one may view hard-rock mining as fast to deploy, but with high marginal cost, while brine extraction is slow to deploy, with low marginal cost but having high capital cost. As the product is ultimately cheaper, and the proven reserves are larger, brine extraction is the favored process. Unfortunately, many natural lithium-containing brine resources contain a mixture of alkali and alkaline earth metals, including sodium, potassium, calcium, and magnesium, in addition to non-metallic contaminants, such as sulfur and boron. As a result, purification is required to isolate lithium, typically as precipitated lithium carbonate (Li₂CO₃). Successful brine extraction operations combine concentration via solar evaporation with careful management of the solubility of different salts to selectively precipitate out impurities until the final lithium-yielding step. The lithium carbonate can then undergo further refinement. A major impediment to this purification process is the presence of magnesium ions in the brine solutions. While divalent ions such as Mg²⁺ are generally less soluble and more easily complexed and precipitated than monovalent ions such as Li⁺, the similar ionic radius of Mg²⁺ and Li⁺ result in the coprecipitation of Mg—Li mineral salts, which can cause a substantial decrease in the yield of lithium from brine production processes. As much as 50% of the lithium in the initial brine solution may be lost due to coprecipitation. The lithium to magnesium ratio is highly correlated to the cost of extracting lithium from a given salt brine resource.

Although methods have been proposed for the selective precipitation of magnesium ions from brines, a major challenge that has frustrated implementation of such methods is the extreme limitation of resources typically available at the sites of extraction. Methods of separating lithium and magnesium ions based on selective sorption and subsequent leaching require chemical reagents, which are expensive to implement in resource-strained areas. Principally, only electrical and solar energy for evaporation are available. Therefore, to overcome the lithium-to-magnesium ratio challenge in a practical setting, a direct extraction process which converts a mechanical or electrical energy source into purification of the lithium product is desired.

Nanofiltration and electrodialysis also have been proposed as membrane-based processes to directly affect the separation of lithium salts. In nanofiltration processes, pressure is applied to drive water flux across a membrane. Solutes additionally flow across the membrane, but at a much lower rate, and ions which are more permeable are enriched over ions which are less permeable. In electrodialysis, an electric field is used to pull cations and anions apart across a stack of alternating cation- and anion-exchange membranes. Salt is concentrated or depleted in alternating cell pairs, which are combined to produce the product streams.

The selectivity of a membrane to two species is defined as the ratio of the permeability of those two species. The permeability can be determined via a diffusion or direct osmosis experiment, by dividing the molar flux of the species by the total driving force. The driving force can, in turn, be related to the external concentration difference across the membrane or, for non-ideal systems, the external chemical activity difference across the membrane. The permeability may also be determined via reverse osmosis. In this case, the membrane rejection, R, is determined, as

$$R = 1 - \frac{{c}_{p}}{{c}_{f}}$$

where cₚ is the concentration of the solute in the permeate and c_{f} is the concentration of the solute in the feed. The permeability is proportional to the term (1-R)/R as well as to the water flux, J_{w}. Thus,

$${a}_{12} = ( \frac{{J}_{w , 1}}{{J}_{w , 2}} ) \cdot {(}^{( 1 - {R}_{1} ) / {R}_{1}} {/}_{( 1 - {R}_{2} ) / {R}_{2}} )$$

$${a}_{12} {\approx }^{( 1 - {R}_{1} ) / {R}_{1}} {/}_{( 1 - {R}_{2} ) / {R}_{2}}$$

can be used to approximate the selectivity between species 1 and 2 from reverse osmosis experiments. Permeability is composed generally of two parameters: the absorption of the solute into the membrane (i.e., how much is there) and the diffusivity of the solute in the membrane (i.e., how fast does it move). Membranes can achieve high selectivity by increasing either parameter.

Nanofiltration membranes utilized for direct lithium extraction typically have selectivities in the range of 2.6-10.4 (Li et al., 2019). For example, Switzer et al. refer to starting and ending concentrations for lithium-containing brine treated with a cellulose acetate nanofiltration membrane (US 2018/0353907). Utilizing the above equation, the approximate Li⁺/Mg²⁺ selectivity may be as high as 13.2.Li et al. refer to higher Li⁺/Mg²⁺ selectivity, i.e., about 30, for polyamide-based nanofiltration membranes (Li et al., 2019). The selectivity of nanofiltration membranes is highly variable depending on the feed composition. Nanofiltration membranes reject ions based on a combination of size-sieving and charge-sieving effects. At high salt concentrations, the salt begins to overwhelm the membrane and selectivity is reduced.

Cation exchange membranes for electrodialysis have permanent negatively charged groups (generally in the form of sulfonate groups) to which cations bind, enhancing their mobility through the membrane. Salt (as the cations and anions in their stoichiometric ratio) also absorbs into the membrane, but at a much lower concentration. The fixed charge groups are saturated at fairly low external salt concentrations, while the internal salt concentration grows as a function of the external salt concentration. As a result, at higher salt concentrations, these membranes typically exhibit lower cation-anion selectivity and lower cation-cation selectivity.

Polymer membranes have typically been formed through the process of nonsolvent-induced phase inversion (NIPS). In NIPS, a solution of polymer and solvent are cast in a uniformly thick layer on a flat surface. The coated substrate is then immersed into a nonsolvent, which is miscible with the solvent but immiscible with the polymer. Through the immersion process, the solvent exits the coating layer and the polymer solidifies forming the membrane. Conventional phase inversion processes generate thermodynamic instability and liquid-liquid de-mixing of the polymer and solvent, leading to the formation of porous voids in the membrane. Such processes have been used to produce porous membranes and integrally skinned asymmetric membranes characterized by a porous layer of polymer with a dense skin layer on top of the porous structure (Loeb-Souriraj an membranes). The ion/ion selectivity of such membranes is generally low, on the order of about 1 to about 5.The original LS membrane recipe was developed for seawater desalination and was thus optimized to maximize the water flux and sodium chloride rejection. To maximize the water flux for desalination, it is was important to minimize the thickness of the relatively dense skin of the membrane. As a result, any potential ion-ion selectivity was compromised in favor of higher water flux (the salt-water selectivity remained sufficiently high for desalination).

Improved membranes having high selectivity are needed, particularly membranes having high Li ion and Li/Mg selectivity for separating lithium from brines and other resources. Methods of producing such membranes as dense nonporous polymer films without any associated and automatically formed porous layer, and which possess properties useful in ion-ion separation and transport systems. Also needed are methods of forming dense, thin films that can quickly form to create dense isotropic membranes, whereby the selectivity and transport properties of ionic species across the membrane are controlled by a substantially homogeneous defect-free film. Such films could be laminated upon other films or supports, to successfully decouple tailoring of the film and the support or other layers, rather than forming them in situ, as with conventional phase inversion. Also needed are membranes fine-tuned for their desired end uses, and which do not include the costs or other negative attributes of prior membranes.

### SUMMARY

The present disclosure provides ion selective membranes comprising an isotropic and nonporous polymer film, the film having a thickness in the range of 0.1 to 100 microns, a density in the range of 0.91 to 1.4 g/cc, a T_{g} in the range of 25 to 450° C., and a Li/Mg selectivity in the range of 50 to 1000.In one aspect, the film comprises a material selected from the group consisting of cellulose acetate, cellulose nitrate, and cellulose butyrate. In another aspect, the film comprises cellulose acetate having an acetylation in the range of 30 to 45 wt %. In yet another aspect, the film comprises a cellulose acetate selected from the group consisting of cellulose acetate ds 1.74, cellulose acetate ds 2.84, and cellulose acetate ds 2.45.

In one example, the ion selective membrane comprises a film having a T_{g} in the range of 120 to 180° C. In another case, the film has a water absorption capacity of approximately 1 to 40%, 2 to 30%, preferably 5 to 20%, and more preferably 8 to 15%. The film can be a single or multi-phase polymeric material. In one aspect, the film is substantially free of MOF particles. In another aspect, the film is substantially free of nanoparticles particles. The film may be free standing or disposed on a support surface.

In an embodiment, the ion selective membrane has a Li/Mg ion selectivity configured to selectively transport Li+/Mg²⁺ in the range of from 50 to about 1000, about 100 to 1000, or about 100 to 800 or more. In one aspect, the film has a crystallinity in the range of about 0 to about 5% by weight. In another aspect, the film has a permeance in the range of from 0.1 GMH to about 2 GMH.

The present disclosure also provides methods of using the membranes to separate a target ion from a non-target ion in a liquid medium. In one aspect, the methods comprise using the membrane for mineral separation, ion separation, water purification, energy conversion, or a combination thereof. In one aspect, the methods comprise using the membrane for the selective removal of Li from a high salinity aqueous solution. In another aspect, the methods use the membrane for the selective removal of Li from a high salinity aqueous solution. In an example, the liquid medium has a variable ionic strength and the membrane advantageously does not lose selectivity when the ionic strength increases.

According to another aspect, the methods can include applying a potential bias to generate an electric field gradient that influences the flow of the target ion through the membrane to thereby separate the target ion from the non-target ion in the liquid medium.

The present disclosure also provides methods where the target ion comprises Li⁺ and the non-target ion comprises Mg²⁺, Ca²⁺, SO₄²⁻, or a combination thereof; and, methods wherein the target ion comprises Li⁺ and the non-target ion comprises Mg²⁺.

In addition, the present disclosure provides systems including the membrane and a solution comprising a target ion and a non-target ion in a liquid medium, such that the target ion and the non-target ion are solvated. In one aspect, the target ion comprises Li⁺ and the non-target ion comprises Mg²⁺, Ca²⁺, SO₄²⁻ or a combination thereof. In one aspect, the target ion comprises Li⁺ and the non-target ion comprises Mg²⁺.

The systems may further include an electrode and a voltage source, wherein the voltage source and electrode are configured to apply a potential bias to generate an electric field gradient that influences the flow of the target ion through the membrane.

In one example, the liquid medium within the system has a variable ionic strength over time and the selectivity of the membrane within the system remains substantially stable even as ionic strength increases.

### BRIEF DESCRIPTION OF THE FIGURES

FIG. 1 shows the estimated water content required to achieve a desired mixture glass transition temperature via the Fox equation for a hypothetical polymer with a known T_{g}.

FIG. 2 depicts a scanning electron microscope cross-section image of a machine coated 5 wt % CA/PAN/75AX membrane per Example 1.The average thickness of the selective layer is approximately 2.5 μm.

FIG. 3 depicts a scanning electron microscope cross-section image of a machine coated 2.5 wt % CA/PAN/75AX membrane per Example 1.The average thickness of the selective layer is approximately 750 nm.

FIG. 4 depicts a scanning electron microscope cross-section image of a machine coated 1.25 wt % CA/PAN/75AX membrane per Example 1.The average thickness of the selective layer is approximately 300 nm.

FIG. 5 shows the lithium ion selectivity for the annealed 5 wt % CA/PAN/75AX membrane of Example 1 against lithium ion permeance in equimolar LiCl:MgCl₂ (0.5 M) binary solution.

FIG. 6 shows the lithium ion selectivity for the annealed (red) and unannealed (blue) fresh (solid circle symbol) and 3-week old (open circle symbol) 2.5 wt % CA/PAN/75AX membrane of Example 1 against lithium ion permeance in equimolar LiCl:MgCl₂ (0.5 M) binary solution.

FIG. 7 shows the lithium ion selectivity for the annealed (red) and unannealed (blue) 1.25 wt % CA/PAN/75AX membrane of Example 1 against lithium ion permeance in equimolar LiCl:MgCl₂ (1 M) binary solution.

FIG. 8 shows the high lithium ion selectivity for the 2.5 wt % CA/PAN/75AX membrane of Example 1 against normalized lithium ion permeance in concentrated lithium brine (triangle symbol), unconcentrated lithium brine A (cross symbol), and unconcentrated lithium brine B (bar symbol). The permeance values were adjusted for the lithium ion concentration or driving force difference between binary and brine solutions for a direct comparison in GMH (grams lithium per meter per hour) units.

FIG. 9 demonstrates the gradual increase of lithium permeance in equimolar LiCl:MgCl₂ (0.5 M) binary solution at pH ˜9 in a membrane per Examples 1 (closed circle) and 2 (open square). The coated 5 wt %, 2.5 wt % and 1.25 wt % CA/PAN/75AX membrane samples are indicated by the green, magenta, and blue closed circles, respectively. The cast 15 wt % and 18 wt % CA are indicated by the blue and orange open squares, respectively.

FIG. 10 shows the absorbance of as-coated 2.5 wt % CA/PAN/75AX as a function of wavenumber. The membrane was not exposed to any salt solution.

FIG. 11 shows the absorbance of 2.5 wt % CA/PAN/75AX that was soaked in concentrated lithium brine solution for ˜330 hours as a function of wavenumber.

FIG. 12 shows the absorbance of 2.5 wt % CA/PAN/75AX that was soaked in unconcentrated lithium brine A solution for ˜330 hours as a function of wavenumber.

FIG. 13 shows the long-term stability of the 2.5 wt % CA/PAN/75AX membrane of Example 1 in equimolar LiCl:MgCl₂ (0.5 M) binary solution at pH ˜9 (red circle).

FIG. 14 shows the absorbance of 2.5 wt % CA/PAN/75AX that was exposed to equimolar LiCl:MgCl₂ (0.5 M) binary solution at pH 9 as a function of wavenumber. The membrane was not exposed to any salt solution. The membrane was exposed to alkaline condition for more than 500 hours and showed signs of degradation during permeation tests after ˜350 hours.

FIG. 15 shows the stability of the 2.5 wt % CA/PAN/75AX membrane of Example 1 in equimolar LiCl:MgCl₂ (1 M) binary solution at pH ˜7 (open circle) and equimolar LiCl:MgCl₂ (0.5 M) binary solution pH ˜9 (closed circle) equimolar binary solution. The permeance values in equimolar (1 M) binary solution were adjusted for the lithium ion concentration or driving force difference between equimolar (1 M) binary and equimolar (0.5 M) binary solutions for a direct comparison in GMH units.

FIG. 16 shows the normalized lithium ion permeance for the 2.5 wt % CA/PAN/75AX membrane of Example 1 against the equimolar LiCl:MgCl₂ (0.5 M) binary solution exposure time at pH ˜9.Brine permeations at pH ˜7 were conducted in between permeation tests in binary solution on some stamps, indicated by the total brine exposure time on the plot. The plot demonstrated that the gradual increase in permeance generally depends on the pH ˜9 binary solution exposure time, despite the long brine exposure.

FIG. 17 shows the normalized lithium ion selectivity for the 2.5 wt % CA/PAN/75AX membrane of Example 1 against the equimolar LiCl: MgCl₂ (0.5 M) binary solution exposure time at pH ˜9.In some cases, brine permeations at pH ˜7 were conducted in between permeation tests in pH ˜9 binary solution, indicated by the total brine permeation time. The plot revealed that the stability degradation window for the membrane lies between ˜170 and ˜350 hours of binary solution exposure. The degradation in performance is dependent on the pH ˜9 binary exposure and independent on the pH ˜7 brine exposure.

FIG. 18 shows the stability of 2.5 wt % CA/PAN/75AX membrane of Example 1 in unconcentrated lithium brine A before and after prolonged exposure in equimolar LiCl:MgCl₂ (0.5 M) binary solution at pH ˜9.The total binary exposure time is indicated. After prolonged exposure in alkaline condition, before the stability degradation window, the membrane exhibited slightly higher permeance and maintained the overall selectivity value. The permeance values were adjusted for the lithium ion concentration or driving force difference between binary and brine solutions for a direct comparison in GMH units.

FIG. 19 shows the stability of 2.5 wt % CA/PAN/75AX membrane of Example 1 in unconcentrated lithium brine A before and after prolonged exposure in equimolar LiCl:MgCl₂ (0.5 M) binary solution at pH ˜9.The total binary exposure time is indicated. After prolonged exposure in alkaline condition, within the stability degradation window, the membrane exhibited slightly higher permeance and lower overall selectivity. The permeance values were adjusted for the lithium ion concentration or driving force difference between binary and brine solutions for a direct comparison in GMH units.

FIG. 20 shows the long-term stability performances of 2.5 wt % CA/PAN/75AX membrane of Example 1 for a total permeation time of 641 hours. The permeation data in 0.5 M: 0.5 M (pH ˜9) and 1 M: 1M (pH ˜7) LiCl:MgCl₂ binary solutions are indicated by open circle and close circle, respectively. The permeance values in equimolar (1 M) binary solution were adjusted for the lithium ion concentration or driving force difference between equimolar (1 M) binary and equimolar (0.5 M) binary solutions for a direct comparison in GMH units.

FIG. 21 shows the lithium ion selectivity for cast 15 wt % CA of Example 2 against lithium ion permeance in equimolar (magenta) LiCl:MgCl₂ (0.5 M) and non-equimolar (blue) LiCl:MgCl₂ (0.5 M:1 M) binary solution.

FIG. 22 shows the lithium ion selectivity for commercial RO membranes (blue), commercial asymmetric CA membranes with a polymer overcoat (green), commercial asymmetric CA membranes (red) against lithium ion permeance in equimolar LiCl:MgCl₂ (1 M) binary solution.

### DETAILED DESCRIPTION OF PREFERRED EMBODIMENTS

The inventors have discovered that thin and dense membranes comprising glassy hydrophilic polymers such as cellulose acetate (CA) can be produced which provide unprecedented Li⁺/Mg²⁺ selectivity, as well as suitable permeance for ion-ion separation and selective transport processes in liquid media. Such polymers can include, for example, cellulose diacetate or cellulose triacetate. Depending on the particular membrane composition, structure and preparation, Li⁺/Mg²⁺ selectivity ratios as high as 1000 can be achieved when using, for example, a cellulose acetate polymer with a percent acetylation in the range of, for example, about 30 to 45%, 32 to 43.5%, about 35 to 42%, preferably about 36 to 41%, and more preferably about 37 to 40%. In an embodiment, the degree of acetylation is approximately 39.5% (e.g., CA ds 2.45, where “ds” is the degree of acetyl substitution). In another embodiment, the cellulose acetate is ds 1.74 with about 32% acetyl content. In a further embodiment, the cellulose acetate is ds 2.84 with about 43.5% acetyl content. This disclosure also provides methods of making and using such high selectivity membranes in ion separation or transport systems.

### Dense Ion Selective Membranes

The present disclosure provides a class of glassy hydrophilic membranes that have significant Li⁺/Mg²⁺ selectivity and thus industrial relevance to ion separation and, in particular, to lithium extraction, including direct lithium extraction (DLE) from brine and other resources. Examples of polymers suitable for use in such membranes include, but are not limited to, cellulose acetate (such as cellulose acetate ds 1.74 (T_{g}≈205° C.), cellulose acetate ds 2.84 (T_{g}≈185° C.)), poly(m-phenylenediamine-trimesoyl chloride) (i.e., polyamide) (T_{g}≈170° C. [18]), cellulose acetate butyrate (T_{g}≈165° C.), cellulose nitrate (T_{g}≈130° C.), poly(cyclohexene carbonate) (T_{g}≈125° C.), poly(c-caprolactam), i.e., Nylon 6 (T_{g}≈47° C.), poly(benzimidazole) (T_{g}≈427° C.), and poly(acrylonitrile) (T_{g}≈105° C.). As taught herein, factors and design of materials to balance, for example, “glassiness” (i.e., the temperature relative to the glass transition temperature, defined as T-T_{g}), water absorption, crystalline content, and polymer free volume, can be utilized to yield desired results in particular situations and applications, including different feed resources (e.g., natural Li-containing brines) and conditions.

“Selectivity” with reference to, for example, lithium selectivity, is defined herein as the ratio of Li ions recovered/feed Li concentration, to the ratio of other ion recovered/other ion feed concentration. The Li⁺/Mg²⁺ selectivity demonstrated by the membranes and teachings herein is significantly higher than the best reported values in the literature, and similarly higher than the more commonly reported Na⁺/Mg²⁺ selectivity. Li⁺ permeability is less commonly measured than Na permeability. The Na⁺/Mg²⁺ selectivity may be used for comparison of literature results because reported Li' and Na permeabilities are similar. Asymmetric “Loeb-Sourirajan-type” (LS) membranes do not have ion-ion selectivity nearly as high as the dense, and preferably isotropic (non-asymmetric), membranes described herein.

The preferred membranes disclosed herein are isotropic and defect-free, as well as dense and nonporous. By “isotropic,” the present disclosure means that the membranes are substantially homogeneous in each direction, in direct contrast to prior membranes prepared by NIPS wherein a porous layer (or a porous layer with a thin skin) was formed (i.e., asymmetric membranes). In this sense, the membranes disclosed herein are non-asymmetric and thus isotropic.

By “nonporous” herein, the present disclosure means that the polymer film is essentially free of permanent holes that span the film from one surface to the opposite surface. In a preferred embodiment, the polymer is manufactured by aspects of nonsolvent-induced film deposition (NIFD) and has no permanent holes that span a sample of the film. The nonporous nature of the polymer film can be determined by, such as, scanning electron microscopy or other suitable imaging techniques. In one embodiment, the polymer membrane comprises a single-phase system and thus has no particles, nanoparticles, or metal organic framework components, etc. dispersed therein.

By “dense,” the present disclosure provides that the membranes are substantially nonporous in contrast to the asymmetric films typically made by the NIPS phase inversion or slow evaporative processes. The membranes disclosed herein typically have a density in the range of, for example, about 0.9 to 1.5 g/cc, preferably about 1 to 1.5 g/cc, more preferably about 1.1 to 1.45 g/cc, and most preferably about 1.2 to 1.4 g/cc. The density may be determined, for example, by the Archimedes Principle, e.g. by measuring the weight of the film, and then determining the volume of the film by submerging it in a solvent such as hexane and measuring the volume of solvent displaced.

The membranes disclosed herein typically have a T_{g} in the range of 25 to 450° C., preferably 80 to 250° C., more preferably 100 to 200° C., and most preferably about 120 to 180° C. The T_{g} may be measure by differential scanning calorimetry or dynamic mechanical analysis.

The membranes are preferably stable under neutral pH. For some CA membranes, alkaline and acidic pH conditions can result in some hydrolysis of acetyl groups depending on the degree of acidity or alkalinity and the duration of exposure. The resulting hydroxyl groups taking the place of acetyl groups can result in increased hydrophilicity and permeance. Thus, pH conditions can be applied to induce controlled hydrolysis and balance permeance with selectivity for specific applications and materials, as discussed herein below.

An additional consideration which can impact membrane performance and ion-ion selectivity is the fraction of crystalline regions present in the polymer. Crystalline regions are typically more densely packed and more-ordered regions of the polymer. Tighter packing can result in reduced ability for permeation. Because CA and other preferred polymeric materials are glassy polymers, they can be produced with a range of crystalline content. In the processes for manufacture discussed herein below, the polymer membrane can be deposited from a liquid state in a manner of only seconds or less, and typically much faster than the kinetics of crystallization. In preferred embodiments, the crystalline fraction of the membrane is very low (ca. 5%) (Irvine et al., 2013; Ohya et al., 2001) compared to films produced via slow evaporation (Puleo et al., 1989), which typically have high crystallinity (about 40%) and are relatively thick. The membranes disclosed herein may have any suitable crystalline fraction, for example, in the range of zero to about 60%, preferably about zero to 40%, more preferably zero to 30%, and most preferably zero to about 5 wt %.

The dense membranes disclosed herein can be relatively this and can have an average thickness. Average thickness can be measured using methods known in the art, such as evaluation by profilometry, cross-sectional electron microscopy, atomic force microscopy (AFM), ellipsometry, veneer calipers, micrometer gauges, or combinations thereof. As used herein, the average thickness is determined by micrometer gauges.

The membrane can, for example, have an average thickness of 50 μm or more (e.g., 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 μm or more, 1.5 μm or more, 2 μm or more, 2.5 μm or more, 3 μm or more, 3.5 μm or more, 4 μm or more, 4.5 μm or more, 5 μm more, 6 μm or more, 7 μm or more, 8 μm or more, 9 μm or more, 10 μm or more, 15 μm or more, 20 μm or more, 25 μm or more, 30 μm or more, 35 μm or more, or 40 μm or more).

In some examples, the membrane can have an average thickness of 50 μm or less (e.g., 45 μm or less, 40 μm or less, 35 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.5 μm or less, 1 μm or less, 900 nm or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, or 100 nm or less).

The average thickness of the membrane can range from any of the minimum values described above to any of the maximum values described above. For example, the membrane can have an average thickness of from 50 nm to 50 μm (e.g., from 100 nm to 50 μm, from 500 nm to 50 μm, from 500 nm to 20 μm, 1 μm to 30 μm, from 1 μm to 10 μm, from 500 μm to 10 μm, or from 500 nm to 5 μm). The average thickness of the membrane can be selected in view of a variety of factors. For example, the average thickness of the membrane can be selected in view of the desired mechanical properties of the membrane, the desired transport properties of the membrane, or combinations thereof.

The membranes can, in some examples, form a free-standing membrane. In some examples, the membrane is supported by a substrate. Examples of suitable substrates include, but are not limited to, polymers (e.g., porous polymers), glass fibers, glass, quartz, silicon, non-woven fibers, and combinations thereof. Unlike with conventional nanofiltration materials, in some embodiments with cellulose acetate the membranes herein do not lose selectivity at higher ionic strengths. We have demonstrated the selectivity of, for example, CA ds 2.45 membranes across a wide range of salt concentrations for single-salt permeation experiments (0.5-1 mol/liter), binary mixed salts, and synthetic and real-world lithium-containing brines. While not wishing to be bound by theory, this may be a consequence of the mechanism of transport across a dense polymer membrane. Water, salt, and neutral solute permeation in cellulose acetate membranes is generally understood to proceed via a solution-diffusion mechanism (Altena, 1982; Reuvers et al., 1986). Species dissolve into the membrane and diffuse across. The key parameters are the amount of material absorbed into the polymer, and the rate at which the material traverses the polymer. While not wishing to be bound by theory, it appears that the diffusivities of Li⁺, Na⁺, and Mg²⁺ are similar (at least of the same order of magnitude) in hydrated CA membranes (Puleo et al., 1989; Vos et al., 1966). Consequently, absorption appears to be the dominant factor in determining selectivity, with the absorption of divalent ions being hampered by the greater degree of hydration of divalent ions, as well as the greater self (or Born) energy of the ions (McCray et al., 1991), thus resulting in a larger energy penalty moving from a high dielectric medium (water) to a low dielectric medium (polymer). On the other hand, in dry cellulose acetate, the activation energy for diffusion (a key parameter in determining the diffusivity of species) demonstrates strong size-sieving (i.e., there is a linear relationship between ion size and activation energy) for alkali metals salts (Reid & Breton, 1959). Together, based on these considerations, it is believed that transport through hydrated regions of CA is responsible for the high degree of selectivity, as dehydrated regions are likely to be strongly size sieving, but the overall diffusivity is similar across different sized ions. The “selectivity” of bulk solution is on the order of 1.2 (Sourirajan).

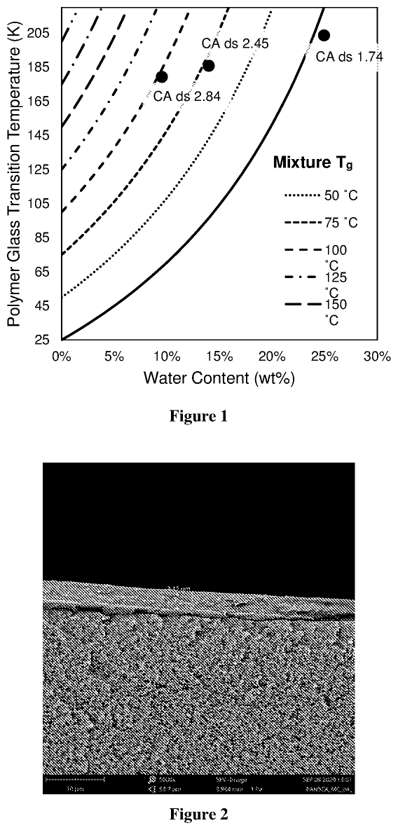

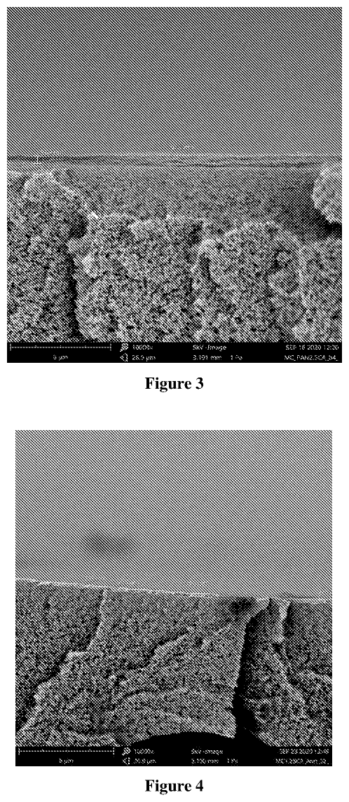

Water absorption into cellulose acetate with an acetyl content of about 39.5% by weight is approximately 10%, whereas for reverse osmosis polyamide-based materials, it is 20-25% (Hancock & Cath, 2009; Hodgson, 1970). As discussed above, cellulose acetate is a glassy material (i.e., the long-range ordering of the polymer is essentially fixed), and the glass transition temperature (T_{g}) of CA ds 2.45 is about 192° C. (Govindan et al., 1966) (measured to be between 187° C. and 198° C.). The Fox equation (Heyde et al., 1975) allows one to estimate the T_{g} of a mixture of two materials as

$${T}_{ℊ , mix} = {[ \sum \frac{{w}_{i}}{{T}_{ℊ , i}} ]}^{- 1}$$

where wᵢ is the mass percent of species i. Using the T_{g} of water (136 K (Su et al., 2010)), the estimated T_{g} of hydrated CA ds 2.45 (i.e. T_{g,mix}) is no lower than about 78° C. (assuming a high value of 13% water uptake, and a low T_{g} value of 187° C.). Thus, hydrated CA ds 2.45 very likely remains a glassy material in the hydrated state. The same cannot be said for CA ds 1.74 (identical estimation utilizing the values of T_{g} and water sorption from Puleo et al. and Lonsdale et al. (1989), respectively, suggest a T_{g} of about 30° C.). Without wishing to be bound by theory, in view of the influence of water on ion selectivity, it is believed that a combination of the glassy nature of CA and the reduced water absorption of, such as, CA ds 2.45, relative to less acetylated materials, results in the remarkable Li/Mg selectivity that we have found in preferred CA embodiments. The modeled water content and polymer T_{g} required to achieve a desired hydrated T_{g} can be determined as shown in FIG. 1 and the above equation. FIG. 1 shows the estimated water content required to achieve a desired mixture glass transition temperature via the Fox equation for a hypothetical polymer with a known T_{g}.

### Methods of Making

Membranes according to the present disclosure may be manufactured by a variety of methods. One method is by depositing a thin coating of polymer solution, followed by evaporation. Such methods are discussed in our co-pending patent application Serial Number PCT/US2020/047953, filed on Aug. 26, 2020, which is hereby incorporated by reference herein in its entirety. In an alternative method, membranes herein may be manufactured by a modified NIPS process, referred to herein as the NIFD process. The inventors have previously described processes for the formation of, among other things, dense and isotropic polymer films via a modified nonsolvent-induced phase separation process in which thermodynamic instability is avoided. See co-pending Patent Applications PCT/US2020/047955, filed Aug. 26, 2020, titled “Methods of Fabricating Polymer Films,” which is hereby incorporated by reference herein in their entireties. In the NIFD process, a carefully chosen nonsolvent system is utilized which preferentially extracts the polymer solvent rather than partitioning into the polymer solution gel and inducing phase separation. The NIFD process allows the production of thin and dense polymer films. Surprisingly, the inventors have now found that some such films have high ion selectivity even without dispersed metal organic framework (MOF) particles. In addition, such films can be produced having no to minimal crystallinity. The preferred NIFD process for preparing the membranes disclosed herein generally entails the formation of a dense polymer film via casting or coating a solution containing polymer and solvent on a flat surface or carrier material and immersing into a non-solvent bath. The NIFD process results when this is carried out using a solvent and nonsolvent chosen such that the polymer is coagulated and set in a manner that deposits a defect-free and dense polymer film having a thickness on the order of hundreds of nanometers to tens of microns. The mechanism of formation is such that the solvent is primarily extracted from the polymer solution, rather than nonsolvent entering into the polymer solution, causing the resulting polymer film to have a density similar to if it was evaporatively dried, and without the formation of porous voids that are traditionally associated with the nonsolvent-induced phase separation process (NIPS). Generally, the NIFD process involves choosing a solvent-nonsolvent pair that has moderate affinity. For example, anhydrous tetrahydrofuran, contingent on the polymer choice, will result in a NIFD film when phase inverted with anhydrous isopropanol, or water containing high concentrations of dissolved salt, such as 6 molal sodium chloride solution, 6 molal lithium chloride solution, or 6 molal calcium chloride solution.

The polymer solution is first deposited at a controlled thickness onto a substrate material. This may be accomplished by spin-coating, doctor blade casting, gravure coating, slot-die coating, dip coating, spray coating or any number of similar techniques. The resulting thin coating of polymer solution is then immersed in a bath of non-solvent for the polymer of choice. Among others, isopropyl alcohol (IPA), n-propyl alcohol, glycerol, lithium chloride in water (such as 6 molal), and calcium chloride in water (such as 6 molal) are suitable non-solvents. Other casting conditions, such as depositing polymer solution coatings which are too thick, results in hybrid structures, in which a nonporous polymer film is formed atop a porous polymer film.

The polymer solution coating typically contracts by 400-800%, resulting in films having a thickness, for example, between 0.1 and 10 microns, and the phase inversion process is generally completed quite rapidly, for example, in 1-10 seconds. The process may be conducted batchwise or continuously and is readily scalable to industrial size continuous production.

It should be apparent that the fabrication methods result in films that are significantly different that those resulting from prior nonsolvent induced phase separations, which result in porous membranes. It is surprising that films formed by aspects of nonsolvent induced film deposition according to the present disclosure would provide nonporous polymers. Generally, nonsolvent phase separation forms combinations of integrally skinned membranes with thick porous layers and thin skins, essentially, an asymmetric porous structure.

The as-deposited solution or mixture film, typically along with the selected substrate or carrier, is then contacted with or immersed in a chosen nonsolvent. Preferably, the solvent and nonsolvent are readily miscible. Suitable examples are provided herein, but other suitable combinations may be used provided that the polymer is insoluble in the nonsolvent. By “insoluble” herein, we mean that only a very small portion, such as <10% by weight, <5% by weight, or preferably, <1% of the polymer dissolves in the nonsolvent. By “miscible” herein, we mean that a very large portion, such that all or essentially all proportions of the solvent present in the as-deposited solution film dissolves in the nonsolvent. As described in more detail below, upon contact or immersion of the polymer solution or mixture in the nonsolvent, a phase inversion occurs wherein the solvent exits the deposited or cast layer, and the polymer rapidly solidifies into a uniform, dense film bathed in a solution of nonsolvent and solvent.

The rapidity of the solidification can be controlled, as discussed herein, and can be remarkably quick, which advantageously permits formation of films via quenching without any convection currents, voids, or associated porous layers, which are characteristics of the prior processes of using nonsolvent phase separation to prepare membranes. As discussed herein, the thicknesses of the cast solution or mixture and of the resulting nonporous film can be tailored to specific end uses and, at least in part, can be manipulated to control the formation of films without associated porous layers, voids, or microcracks. The dense film or mixed-matrix polymer film can then be removed from the substrate or carrier, or the substrate or carrier can comprise or be part of the resulting polymer film membrane.

The polymer films produced by the present disclosure can be subsequently deposited on a substrate (such as a different substrate than the substrate or carrier used during manufacturing the film) to form a composite membrane. For instance, two or more films made by the present disclosure may be laminated together to achieve chemical species separation properties in gas or liquid separations. Use of aspects of the disclosed methods also advantageously allows fabrication in which the film fabrication and the properties of the desired support, if any, are decoupled. This allows for fine tuning of film support combinations because a porous polymer support is not an automatic component of the as-fabricated film, as in conventional phase inversion processes. In addition, the polymer solidification is rapid, allowing lamination of like or otherwise miscible or soluble polymer components on one another.

In order to appropriately mix the polymer and the solvent, the polymer should be soluble in the solvent, as defined herein. Thus, the polymer can readily dissolve in the solvent to form a solution of the polymer in the solvent. Prior to mixing, the polymer can be a liquid or a solid. For instance, the polymer can be initially provided as a powder or granule of the desired polymer. Alternatively, the polymer can be in a liquid form, already dissolved or suspended into a solution or carrier liquid. Prior to mixing, the solvent should be in a liquid form. Mixing together the polymer and solvent results in a “dope solution,” which is a solution, suspension or mixture containing solvent and polymer.

Preferably, a polymer is selected that can form a nonporous isotropic and stable film. The polymer can consist of or include, for example, cellulose, cellulose acetate, polysulfone, poly(amideimide), polybenzimidazole, polyethersulfone, polyphenylsulfone, polyimide, polyacrylonitile, poly (ethylene oxide), poly(ether ether ketone), poly(vinylidene fluoride), poly(ethylene chlorotrifluoroethylene), polycarbonate, polystyrene, poly(ether-block-amide), acrylonitrile butadiene styrene, and derivatives and combinations of the aforementioned. The polymer can similarly comprise bisphonenolsulfone (BPS) polymers and derivatives thereof. The polymer can also include sulfonated polymer derivates, for example, sulfonated poly(ether ether ketone), sulfonated polysulfone, and sulfonated poly (ether sulfone). The polymer can include mixtures or combinations of any of the aforementioned polymers and other suitable polymers. In one aspect of the present disclosure, a preferred polymer is cellulose acetate.

The solvent can further be selected depending on the ability of the solvent to successfully coat a film layer on a substrate or carrier at a desired uniform thickness. Upon mixing, such as sonication or other methods, the polymer molecules disperse throughout the solvent thereby resulting in a homogeneous system. Suitable solvents for use with respective polymers depend on the solubility of the polymer in the solvent. Suitable solvents can consist of or include any of tetrahydrofuran (THF), N-methyl-2-pyrrolidone, tetrahydrofuran/N-methyl-2-pyrrolidone blends, and N,N-dimethylacetamide. The solvent similarly may also comprise acetamide derivatives, for example, diethylacetamide and methylethyleacetamide. The solvent may also include, for example, additional or alternative amide solvent derivatives, such as, dimethylformamide and methylethylformamide The solvent also can be or include methyl-tetrahydrofuran, gamma-valerolactone, dihydrolevoglucosenone, and methanesulfonic acid. The solvent can be formed of any of these or other suitable solvents as a single component or may be formed from a combination of such solvents.

The process of mixing the polymer and the solvent includes mixing a suitable concentration of polymer in the solvent given to the teachings herein. The polymer is mixed at a concentration below its solubility limit (e.g. 60-95%, in some cases, but as low as 10-20% in others). However, at very low concentrations, the solution will not form a film via methods other than evaporation. Without wishing to be bound by theoretical mechanisms of film formation, the “critical entanglement concentration”, i.e., the concentration of solution above which polymer molecules may broadly be described as entangled with other polymer molecules, may typically be between 2 wt % to 10 wt % polymer depending on both the solvent and the polymer molecular weight and may be regarded as a lower practical concentration limit. For example, the mass ratio of the polymer to solvent can be from 5-40% by mass, or preferably 10-30% by mass, or more preferably 10-20% by mass. In particular, the polymer must be soluble in the solvent at the desired concentration. Generally higher molecular weight polymers form films at lower concentrations of polymer. The concentration of polymer to be included may be determined by desired characteristics for depositing the dope solution on the substrate or carrier, and the nature of the substrate or carrier. For example, depending on the thickness of the deposition, the desired nonporous film thickness, a desired viscosity for deposition, either a greater or lesser concentration of polymer can be included in the solvent. The concentration of polymer reflects the thickness for deposition of the material on the substrate or carrier, and also the thickness of the resulting nonporous polymer film or mixed-matrix polymer film. The “transitional thickness”, t*, is the thickness at which the polymer liquid film may be coated in the nonsolvent induced film deposition (NIFD) process to form a dense nonporous isotropic film and can be determined for a given polymer dope solution and nonsolvent composition given the teachings herein. At thicknesses above this value, comparatively thick polymer films with discrete porous voids will be formed. In this case, an integrally skinned membrane may be formed, however the ratio of porous volume to non-porous film volume with be much higher than in the known nonsolvent-induced phase separation process. For example, in casting a film slightly above the transitional thickness t*, a polymer film with 10%, 5%, or as low as 1%, porous volume may be formed. Casting a film below the transitional thickness t* will result in a film with no visible porous voids. In contrast, integrally skinned membranes produced via conventional nonsolvent-induced phase separation may have porous volume of 50%, 80%, or often in excess of 90%. The present disclosure includes teachings that allow an individual of ordinary skill in the art to produce polymer dope solution and nonsolvent compositions which result in surprisingly large transitional thicknesses in the range of 1 to 100 microns, and surprisingly large contraction ratios in the range of 100% to as large as 1600%.

Generally, dope solution formulations which produce dense skin layers will produce a certain thickness skin layer dependent on the properties of the polymer dope solution and the nonsolvent bath. The self-limiting thickness of the nonporous layer may be regarded as the maximum film thickness that can be achieved via the nonsolvent-induced film deposition (NIFD) method. Consequently, the maximum thickness at which the dope solution may be deposited on a substrate will be the dope solution film that contains the same amount of polymer as the dense film at its self-limiting thickness.

After the solution is deposited on the substrate or carrier, the substrate or carrier along with the deposited dope solution is contacted with, or immersed in, a nonsolvent to effect a phase change of the dope solution or nanoparticle dope solution into a nonporous polymer film. The nonsolvent effects the phase change of the dope solution by removing the solvent and allowing the polymer to rapidly solidify, thereby creating a nonporous polymer of a desired thickness on the substrate or carrier. Suitable nonsolvents are selected that are miscible with the solvent but not the polymer. Thus, by immersing the dope solution in the nonsolvent, the solvent rapidly exits the polymer and a polymer film is formed. During solidification of the polymer, the thickness of the as- cast or deposited dope solution is reduced to the polymer film thickness by a factor typically in the range of 400% to 800% reduction in thickness, but has been demonstrated to be as high as 1600% in some cases herein. The reduction in thickness can also be smaller, depending on the amount of solvent in the nanoparticle dope solution, the chilled temperature of the nonsolvent, and other factors.

Suitable nonsolvents depend on both the polymer and the solvent. The following nonsolvents are particularly suitable for use with certain polymers referred to in the present disclosure: isopropyl alcohol, glycerol, hexane, solution of lithium chloride in water at a concentration of, for example, 6 molal, and solutions of calcium chloride in water at a concentration of, for example, 6 molal. The nonsolvent can also be liquid alkanes at room temperature, for example, heptane, cyclohexane, and isocetane. The nonsolvent can also be liquid polyethylene glycol and its derivatives, for example, polyethylene glycol having an average molecular weight of 200, 400, or 600.The nonsolvent can be an alcohol, for example, 1-propanol, butanol (and its derivatives), and pentanol (and its derivatives). The nonsolvent can be glycerol, ethylene glycol, propylene glycol (and its derivatives), liquid sugars, and sugar alcohols. The nonsolvent can be acetates, for example ethyl acetate and butyl acetate. The nonsolvent can include aromatic compounds, for example, toluene and xylene. The nonsolvent can include water and saturated systems, for example, salt brine in water, concentrated sugar solution, and water-organic mixtures. The nonsolvent can be a single compound or can be a combination of these compounds. The most important aspect of the nonsolvent is that it is selected because it is miscible with the selected solvent and immiscible with the polymer. The nonsolvent should be selected to work with the polymer and the solvent in a manner that achieves rapid removal of the solvent from the deposited dope solution. The nonsolvent is chosen such that it interacts with the solvent at a rate that permits deposition of a single nonporous polymer film without a porous layer, voids, or microcracks.

The dope solution can be wet processed, dry-wet processed, or wet-wet processed. In wet processing, the solution is deposited on the substrate or carrier and then immersed directly in the nonsolvent to affect the desired phase change. In dry-wet processing, the solution is deposited on the substrate or carrier and prior to immersion in the nonsolvent, is contacted with air. In wet-wet processing, the is deposited on the substrate, contacted with a first nonsolvent, and then contacted with a second nonsolvent. Any of the described nonsolvents can function as either the first or second nonsolvent in a wet-wet process.

### Systems and Methods of Use

The membranes can be used to separate a target ion from a non-target ion in a liquid medium (e.g., in an aqueous solution). In some examples, the membranes described herein can be used for mineral separation, ion separations, water purification, energy conversion, or a combination thereof. In some examples, the membranes described herein can be used for the selective removal of Li from a high salinity aqueous solution in a continuous process.

Also disclosed herein are systems comprising any of the membranes disclosed herein and liquid medium comprising the target ion and the non-target ion, such that the target ion and the non-target ion are solvated. Also disclosed herein are systems comprising any of the membranes disclosed herein and an aqueous solution comprising the target ion and the non-target ion, such that the target ion and the non-target ion are hydrated. In some examples, the systems can further comprise an electrode and a voltage source, wherein the voltage source and electrode are configured to apply a potential bias to generate an electric field gradient that influences the flow of the target ion through the membrane. Also disclosed herein are methods of use of the systems described herein, the method comprising applying a potential bias to generate an electric field gradient that influences the flow of the target ion through the membrane to thereby separate the target ion from the non-target ion in the liquid medium (e.g., in the aqueous solution). Patent applications PCT/US2020,/047953, filed Aug. 26, 2020, titled “MIXED MATRIX MEMBRANES AND METHODS OF MAKING AND USE,”; and PCT/ US2020/047955, filed Aug. 26, 2020, titled METHODS OF FABRICATING POLYMER FILMS AND MEMBRANES, each of which are hereby incorporated herein by reference in their entireties, also refer to systems and methods in which the membranes of the present disclosure may be used.

The membranes can exhibit a selectivity for the target ion over the non-target ion of, for example, 50 or more (e.g., 60 or more, 70 or more, 80 or more, 90 or more, 100 or more, 150 or more, 200 or more, 250 or more, 300 or more, 350 or more, 400 or more, 450 or more, 500 or more, 600 or more, 700 or more, 800 or more, 900 or more, 1000 or more, 1250 or more, or 1500 or more). In some examples, the membranes can exhibit a selectivity for the target ion over the non-target ion of 2000 or less (e.g., 1750 or less, 1500 or less, 1250 or less, 1000 or less, 900 or less, 800 or less, 700 or less, 600 or less, 500 or less, 450 or less, 400 or less, 350 or less, 300 or less, 250 or less, 200 or less, 150 or less, 100 or less, 90 or less, 80 or less, 70 or less, 60 or less, or 50 or less). The membranes can exhibit a selectivity for the target ion over the non-target ion that ranges from any of the minimum values described above to any of the maximum values described above. For example, the membranes can exhibit a selectivity for the target ion over the non-target ion of from 50 to 2000 (e.g., from 50 to 1000, from 1000 to 2000, from 100 to 1000, from 100 to 500, from 500 to 2000, from 50 to 100, from 50 to 800, or from 50 to 1000).

The liquid medium can comprise any suitable liquid medium, for example any liquid medium in which the target ion and non-target ion are soluble while the polymer is substantially insoluble and/or impermeable. For example, the liquid medium can comprise water, tetrahydrofuran (THF), N-methyl-2-pyrrolidone (NMP), dimethylformamide (DMF), dimethyl sulfoxide (DMSO), dimethylacetamide, dichloromethane (CH₂Cl₂), ethylene glycol, ethanol, methanol, propanol, isopropanol, acetonitrile, chloroform, acetone, hexane, heptane, toluene, methyl acetate, ethyl acetate, or combinations thereof. In some examples, the liquid medium comprises water (e.g., an aqueous solution). In some examples, the liquid medium can comprise a salt solution, produced water (e.g., from mining, fracking, oil recovery), brine, or a combination thereof.

The target ion, the non-target ion, or a combination thereof can have a concentration in the liquid medium of from greater than 0 M to saturation. For example, the concentration of the target ion, the non-target ion, or a combination thereof in the liquid medium can be greater than 0 M or more (e.g., 0.001 M or more, 0.005 M or more, 0.01 M or more, 0.05 M or more, 0.1 M or more, 0.2 M or more, 0.3 M or more, 0.4 M or more, 0.5 M or more, 0.6 M or more, 0.7 M or more, 0.8 M or more, 0.9 M or more, 1 M or more, 1.5 M or more, 2 M or more, 2.5 M or more, 3 M or more, 3.5 M or more, 4 M or more, 4.5 M or more, 5 M or more, 6 M or more, 7 M or more, or 8 M or more). In some examples, the concentration of the target ion, the non-target ion, or a combination thereof in the liquid medium can be less than saturation (e.g., 100 M or less, 50 M or less, 10 M or less, 9 M or less, 8 M or less, 7 M or less, 6 M or less, 5 M or less, 4.5 M or less, 4 M or less, 3.5 M or less, 3 M or less, 2.5 M or less, 2 M or less, 1.5 M or less, 1 M or less, 0.9 M or less, 0.8 M or less, 0.7 M or less, 0.6 M or less, 0.5 M or less, 0.4 M or less, 0.3 M or less, 0.2 M or less, 0.1 M or less, 0.05 M or less, or 0.01 M or less). The concentration of the target ion, the non-target ion, or a combination thereof in the liquid medium can range from any of the minimum values described above to any of the maximum values described above. For example, the concentration of the target ion, the non-target ion, or a combination thereof in the liquid medium can be from greater than 0 M to saturation (e.g., from 0.001 M to 1000 M, from 0.001 M to 100 M, from 0.001 M to 10 M, from 0.1 M to 5 M, 0.1 M to 1 M, or from 0.1 M to 0.3 M).

The target ion and the non-target ion can comprise any suitable ions. For example, the target ion can comprise a monovalent ion and the non-target ions can comprise a divalent ion. In some examples, the monovalent ion can comprise an alkali metal cation, a halide anion, or a combination thereof. In some examples, the target ion comprises Li⁺ and the non-target ion comprises Mg²⁺, Ca²⁺, SO₄²⁺, or a combination thereof. In some examples, the target ion comprises Li⁺ and the non-target ion comprises Mg²⁺.In some examples, the target ion comprises Cl⁻ and the non-target ion comprises SO₄²⁻. In some examples, the target ion comprises F⁻ and the non-target ion comprises Cl⁻.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### A. Membrane Fabrication

Symmetric or dense cellulose acetate (CA)-based membranes were fabricated via nonsolvent-induced film deposition (NIFD) casting or coating procedures. The membrane thickness was measured using a digital thickness gauge or through a cross-sectional scanning electron microscope (SEM) characterization.

### Example 1: Preparation of Coated Dense Cellulose Acetate Membranes

A dense cellulose acetate membrane having high Li/Mg selectivity of ˜100 was prepared from polymer dopes comprising ˜5 wt %, ˜2.5 wt % or 1.25 wt % CA in THF. The CA powder was first dried overnight under vacuum at room temperature. To prepare the dope solution, the dried CA was added into THF (˜5 wt %, ˜2.5 wt % or 1.25 wt %) and stirred for 1 day until the CA was fully dissolved. The solution was then coated on a polyacrylonitrile (PAN) ultrafiltration support deposited on a 75AX paper at a feed rate of 2 ft/min. Evaporation time and conditions were 80 degrees C. for 30 min. Post-treatment such as annealing at 80° C. for minutes was performed on some samples and found to be optional. SEM images of the CA/PAN/75AX membranes are shown in FIG. 1-FIG. 3, revealing membrane thicknesses of about 2.5 μm, 750 nm, and 300 nm, respectively. These membranes were prepared from the ˜5 wt %, ˜2.5 wt % or 1.25 wt % CA in THF dope solutions, respectively.

### Example 2: Preparation of Cast Dense Cellulose Acetate Membranes

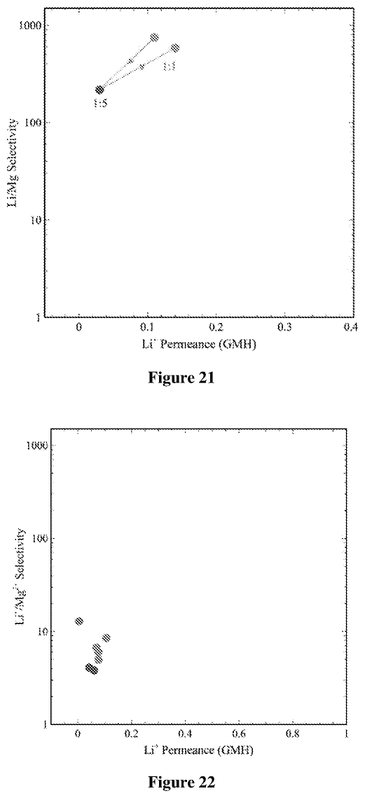

Dense cellulose acetate membranes (5-15 μm thickness) having high Li/Mg selectivity of ˜100 were prepared from a casting dope comprising of ˜15 or ˜18 wt % CA in THF. The CA powder was first dried overnight under vacuum at room temperature. To prepare the dope solution, the dried CA was added into THF (˜15 wt % or ˜18 wt %). The membrane was cast onto a flat surface using a doctor blade with a 30-micron gap setting and immediately immersed in a nonsolvent bath (water or 7.5 molal LiCl bath), followed by washing in water. During washing, the bath was exchanged with ˜3-6 L of fresh water at least twice within 2-3 hours. The final membrane thicknesses were approximately 6 and 15 μm for the ˜15 wt % and ˜18 wt % CA dope solutions, respectively. The membrane sheets were stored in water until further use. The detailed NIFD procedure is described in our co-pending US Patent Application PCT/US2020/047955.The membranes can be tested as free-standing film or may be placed with or cast directly on a porous support e.g., PAN, 75AX, Toray® or Texlon® in order to provide an additional mechanical support during testing. For the tests shown in FIG. 21, the membrane films were placed onto a PAN/75AX support (not directly cast on the support) and loaded onto the permeation cell setup.

### Membrane Performance Measurements and Analysis

Membrane performances were measured using concentration-gradient liquid permeation test cells or cross flow test cells. In a concentration-gradient permeation setup, two glass cells were clamped together with a flat-sheet membrane sample and sealing gaskets in between them. The active membrane area, where the membrane surface was exposed to the feed solution, was ˜1.8 or ˜5.1 cm².The feed cell was filled with salt solution while the permeate cell was filled with deionized water. Magnetic stirring was used in each cell throughout the permeation tests. The long-term performance and stability of the membrane sample can be evaluated in longer duration cycling tests. The loaded membrane samples were soaked in distilled water (on both permeate and feed sides) for 30 mins-1 hour prior to measurement. For repeat measurements, the membrane samples were soaked in distilled water (on both permeate and feed sides) for ˜2 hours and exchanged with fresh distilled water at least twice until the conductivity values reached ≤10 μS/cm, followed by rinsing in DI water before conducting the next permeation run to ensure the removal of residual ionic species from the previous run.

All permeance data was collected at room temperature. The concentration of the permeate species was analyzed using Flame AA atomic absorption spectroscopy, and to evaluate the salt transport properties. To ensure the accuracy of measurements, samples were measured in triplicates and the values were averaged, and a reference sample was run along with the actual samples per set of runs. The reference sample was selected from a previously measured sample obtained from the previous set of runs. The experiments demonstrated high ion separation performance of CA-based membranes prepared as in Examples 1 and 2, compared to conventional CA membranes. See FIG. 22.

### Example 3: Lithium Separation Properties of Coated CA/PAN/75AX

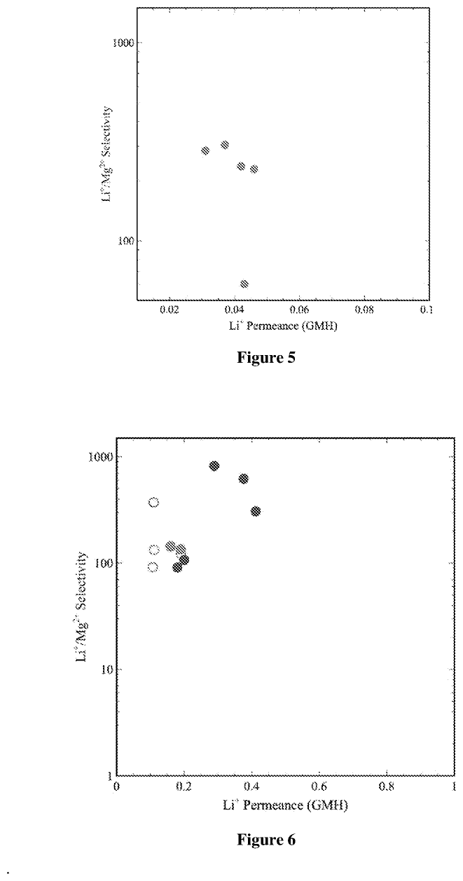

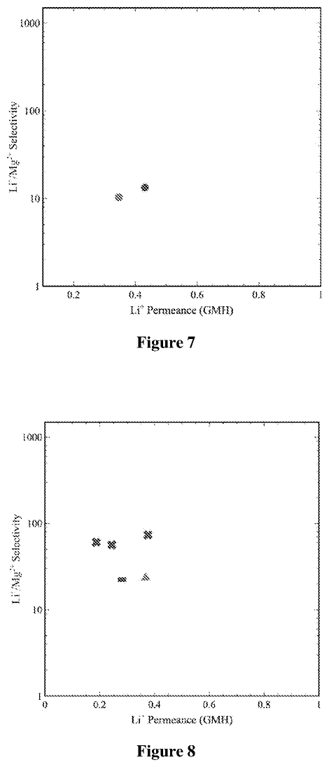

The ability of dense CA membrane, prepared as in Example 1, to separate lithium from magnesium was determined in a simple binary mixture and in complex real-brine mixtures. The membrane performances at room temperature are shown in FIG. 5-FIG. 7. In a simple binary salt mixture, high lithium ion selectivity of >100 can be achieved with lithium ion permeance of ˜0.06 GMH (grams of lithium per meter squared per hour) for 5 wt % CA/PAN/75AX and ˜0.3 GMH for 2.5 wt % CA/PAN/75AX (FIG. 5 and FIG. 6). The observed permeance and selectivity of the thinner 1.25 wt % CA/PAN/75AX were ˜0.4 GMH and ˜10, respectively (FIG. 7). In concentrated lithium and unconcentrated lithium brine mixtures, 2.5 wt % CA/PAN/75AX displayed selectivity values of >10-100 with r adjusted lithium ion permeance values of ˜0.3 GMH (FIG. 8). The compositions of the salt mixtures in the different brine samples are provided in Table 1.

### Example 4: Use of Partially Hydrolyzed CA-Based Membranes

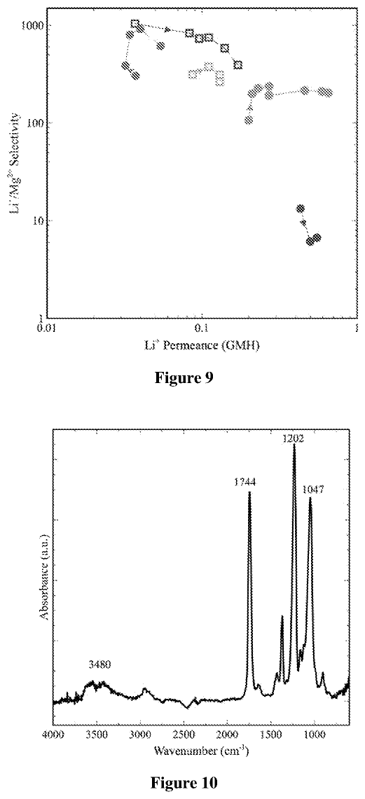

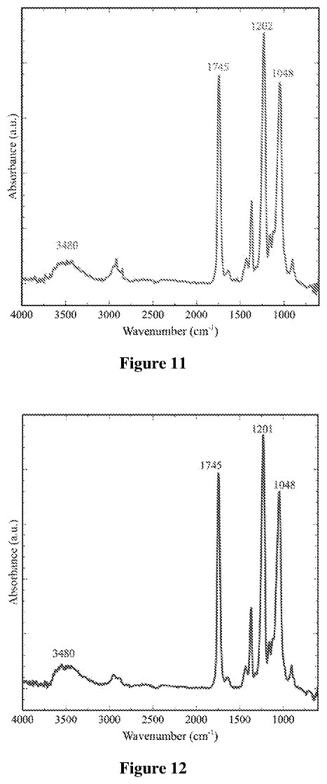

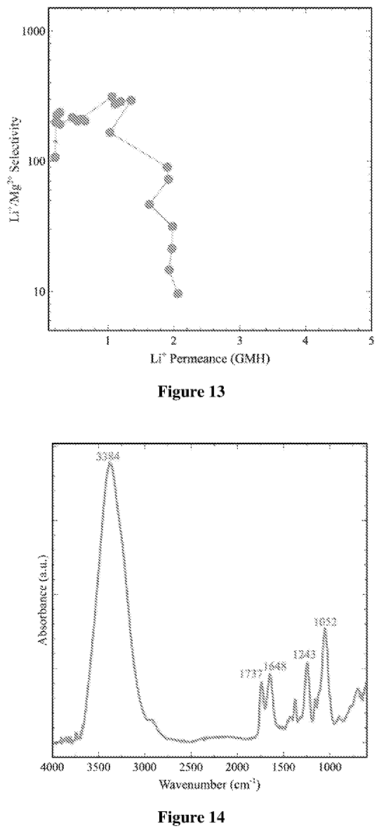

The membranes prepared as in Examples 1 and 2, have somewhat reduced stability under alkaline conditions (e.g., pH ˜9). FIG. 9 shows that the lithium ion permeance of CA-based membranes gradually increased after each permeation run while maintaining an overall high selectivity. Cellulose acetate can be hydrolyzed by acid or base[7,8]. It is likely that partial hydrolysis slowly took place on the membrane samples over multiple permeation tests at room temperature. FIG. 10-FIG. 13 plot the FTIR spectra of 2.5 wt % CA/PAN/75AX membrane samples with and without exposure to various salt solutions at different pH levels. To ensure the removal of excess water molecules, membrane samples that have been exposed to binary or brine solutions were evacuated overnight under vacuum at room temperature. The FTIR spectrum of the as-coated membrane samples feature the characteristic —OH peak from hydroxyl groups, and —C═O and —C—O peaks from acetyl groups at 3480 cm-1, 1744 cm-1, and 1202 cm-1, respectively (FIG. 10). The peaks due to the acetyl groups are more intense compared to the hydroxyl peak (FIG. 10). The spectra of the membrane samples that were soaked in concentrated brine solution (FIG. 11) and unconcentrated brine solution A (FIG. 12), which have pH levels of 3 and 8, respectively, correspond well to that of the as-coated membrane sample (FIG. 10). The brine exposure time on these stamps is ˜330 hours. The membrane sample that was exposed to LiCl:MgC12 (0.5 M) binary solution at pH 9 for ˜500 hours, in which signs of degradation during permeation tests were observed after 350 hours (FIG. 13), was also analyzed. Partial hydrolysis on this membrane is evidenced by the dominant hydroxyl peak and weaker peak intensities due to the acetyl groups, as shown in FIG. 14. The deacetylation process results in the increase of the more hydrophilic hydroxyl groups over the less hydrophilic acetyl group, making the membrane more permeable (FIG. 9).

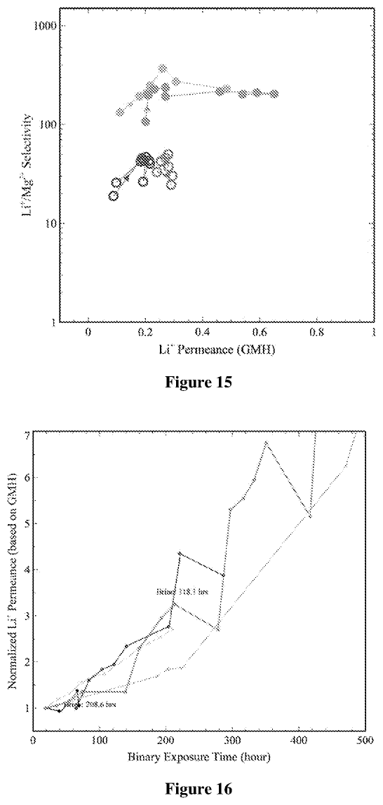

The performances in binary mixtures at pH ˜7 and pH ˜9 also were compared and are shown in FIG. 15. The Li permeance in the pH ˜9 mixture gradually decreased after each permeation run, while in pH ˜7 little to no changes were observed. FIG. 16 shows that the gradual increase in permeance depends on the alkalinity of the solution and is independent on the brine exposure time at neutral conditions. There appears to be a threshold where the selectivity starts to decline (FIG. 13). The estimated degradation window in pH ˜9 binary solution is shown in FIG. 17. The membrane properties can thus be enhanced by tuning the degree of acetyl and hydroxyl contents to increase the permeance up to the point at which the membrane could potentially become unduly unstable.

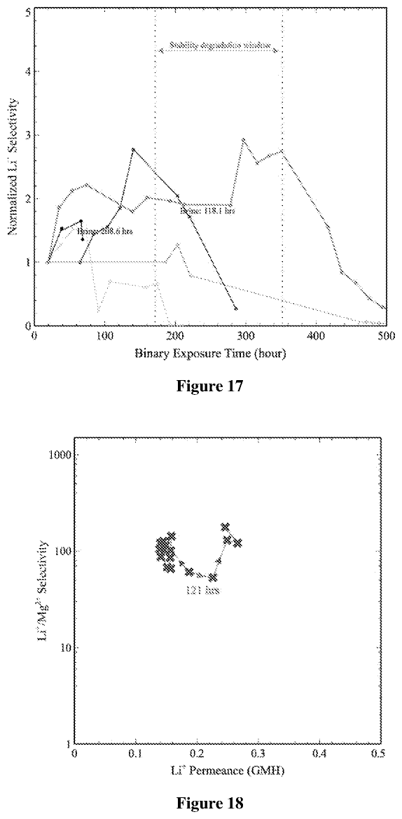

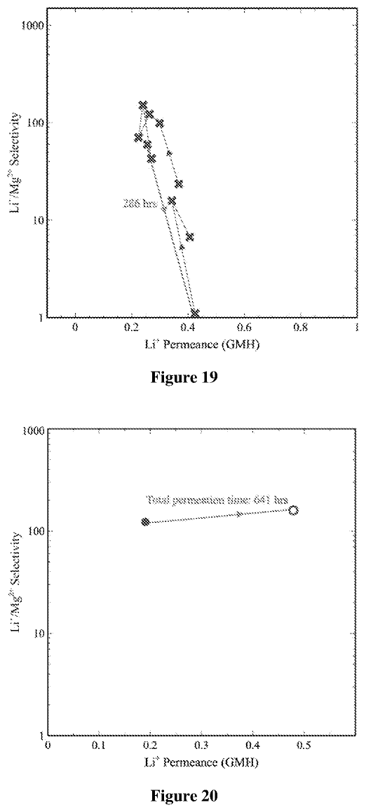

Compared to the 2.5 wt % CA/PAN/75AX membrane (FIG. 6), the fabrication of a thinner membrane (1.25 wt % CA) slightly increases the permeance at a cost of a lower selectivity (FIG. 7). FIG. 13 (2.5 wt % CA) shows that permeance enhancement of up to 10-fold without sacrificing selectivity can be achieved under alkaline condition. The higher adjusted permeance can be maintained when operated in neutral or lower pH solutions before it reaches the degradation window, as shown in FIG. 18. Once it reached the degradation window, higher adjusted permeance was observed as well as a lower overall selectivity, as shown in FIG. 19.

### Example 5: Long-Term Stability of Coated CA/PAN/75AX

The long-term 2.5 wt % CA/PAN/75AX membrane as prepared as in Example 1 performance in binary and brine solutions are shown in FIGS. 15, 18, and 19. As discussed in Example 4, the membrane in pH ˜7 binary solution did not gradually increase in permeance. The membrane still showed stable performances in pH ˜7 binary permeation tests for ˜224 hours of consecutive runs (FIG. 15). In brine solutions, prior to long-term pH ˜9 binary solution exposure, the permeance and overall selectivity did not gradually increase over multiple runs in concentrated lithium brine and unconcentrated lithium brine A. The membrane samples still showed stable performances for ˜100-200 hours of consecutive runs (FIG. 18 and FIG. 19). Aged membrane samples were also evaluated. FIG. 6 showed that the annealed and unannealed membrane samples after 3-week storage at ambient conditions still maintained good lithium separation performances. FIG. 20 shows the long-term permeation performance before and after prolonged exposure in equimolar LiCl:MgCl₂ (0.5 M) binary solution at pH ˜9 for ˜121 hours, unconcentrated lithium brine B at pH ˜8 for ˜115 hours, unconcentrated lithium brine A at pH ˜7 for ˜277 hours and equimolar LiCl: MgCl₂ (1 M) binary solution at pH ˜7 for ˜128 hours (a total permeation time of ˜641 hours). The membrane sample still maintained a high lithium selective performance in long term testing. The permeance value increased by ˜0.3 GMH due to its exposure in alkaline condition.

### Example 6: Influence of Mg:Li Ratio on the Membrane Performance

Some brines may have a high Mg:Li ratio. The performance of 15 wt % CA membrane, prepared as in Example 2, was evaluated in equimolar (0.5 M) and non-equimolar (0.5 M:1 M) LiCl: MgCl2 binary solutions, as shown in FIG. 21. At higher Mg:Li ratios, the lithium permeance was lower. The membrane was still lithium selective and maintained a high selectivity value.

### Example 7: Comparative Performance of CA-Based Membranes Prepared in Examples 1 and 2 Against Commercial Membranes

FIG. 22 shows the performance of commercial asymmetric CA membranes and reverse osmosis (RO) membranes in equimolar (0.5 M) binary mixtures of lithium chloride and magnesium chloride at room temperature. The results show that these commercial membranes showed much lower selectivity of ≤10 and lower permeance than the CA-based membranes prepared in Examples 1 and 2 (FIGS. 5, 6, and 9). The commercial membranes included ESPA-DHR, provided by Nitto Hydranautics, which is a composite polyamide membrane with a polysulfone porous support and a polyester backing, and MTR Orion cellulose acetate-based membranes with and without a polymer overcoat.

The compositions, devices, and methods of the appended claims are not limited in scope by the specific devices and methods described herein, which are intended as illustrations of a few aspects of the claims and any devices and methods that are functionally equivalent are within the scope of this disclosure. Various modifications of the compositions, devices, and methods in addition to those shown and described herein are intended to fall within the scope of the appended claims. Further, while only certain representative compositions, devices, and methods, and aspects of these compositions, devices, and methods are specifically described, other compositions, devices, and methods and combinations of various features of the compositions, devices, and methods are intended to fall within the scope of the appended claims, even if not specifically recited. Thus, a combination of steps, elements, components, or constituents can be explicitly mentioned herein; however, all other combinations of steps, elements, components, and constituents are included, even though not explicitly stated.

TABLE 1
Lithium and magnesium content in real brine mixtures tested on CA-based membranes

| | Concentrated Li- | Unconcentrated Li- | Unconcentrated Li- |
|---|---|---|---|
| | Brine | Brine A | Brine B |
| Amount (ppm) | (pH 3) | (pH 7) | (pH 8) |
| Lithium | 20000 | 790 | 1400 |
| Magnesium | 80000 | 1100 | 22 |

| | | | |
|---|---|---|---|
| | | | Li permeance |
| Example | Test: | Li/Mg selectivity | (GMH) |

All raw data

| | | | |
|---|---|---|---|
| Example 1 | Annealed 5% CA (FIG. 5) | 216 ± 82 | 0.040 ± 0.005 |
| | Annealed 2.5% CA (FIG. 6) | 139 ± 5 | 0.18 ± 0.02 |
| | Unannealed 2.5% CA (FIG. 6) | 414 ± 294 | 0.28 ± 0.10 |
| | Annealed 2.5% CA Aged (FIG. | 112 ± 30 | 0.11 ± 0 |
| | 6) | | |
| | Unannealed 2.5% CA Aged (FIG. | 372 | 0.145 ± 0.064 |
| | 6) | | |
| | Annealed 1.25% CA (FIG. 7) | 10 | 0.35 |
| | Unannealed 1.25% CA (FIG. 7) | 13 | 0.43 |
| | 2.5% CA: Brine A (FIG. 8) | 47 ± 12 | 0.27 ± 0.09 |
| | 2.5% CA: Brine B (FIG. 8) | 22 | 0.28 |
| | 2.5% CA: Concentrated Brine | 74 | 0.38 |
| | (FIG. 8.) | | |
| Example 2 | 2.5% CA (1:1 Li:Mg) (FIG. 21) | 666 ± 118 | 0.15 ± 0.06 |
| | 2.5% CA (1:2 Li:Mg) (FIG. 21) | 217 | 0.03 |

Raw data (simplified: all compared at similar test conditions)

| | | | |
|---|---|---|---|
| Example 1 | Annealed 5% CA (FIG. 5) | 216 ± 82 | 0.040 ± 0.005 |
| | Annealed 2.5% CA (FIG. 6) | 139 ± 5 | 0.18 ± 0.02 |
| | Annealed 1.25% CA (FIG. 7) | 10 | 0.35 |
| Example 2 | 2.5% CA (1:1 Li:Mg) (FIG. 21) | 666 ± 118 | 0.15 ± 0.06 |

| | |
|---|---|
| Li/Mg selectivity | Li permeance (GMH) |

Example 1 FIG. 5: 5% CA

| | | |
|---|---|---|
| Annealed | 248 | 0.031 |
| stamp 1 | | |
| Annealed | 230 | 0.046 |
| stamp 2 | | |
| Annealed | 237 | 0.042 |
| stamp 3 | | |
| Annealed | 60 | 0.043 |
| stamp 4 | | |
| Annealed | 304 | 0.037 |
| stamp 5 | | |

Example 1 FIG. 6: 2.5% CA

| | | |
|---|---|---|
| Annealed | 135 | 0.19 |
| stamp 1 | | |
| Annealed | 143 | 0.16 |
| stamp 2 | | |
| annealed | | |
| Unannealed | 91 | 0.18 |
| stamp 1 | | |
| Unannealed | 107 | 0.2 |
| stamp 2 | | |
| Unannealed | 818 | 0.29 |
| stamp 3 | | |
| Unannealed | 620 | 0.38 |
| stamp 4 | | |
| Unannealed | 542 | 0.28 |
| stamp 5 | | |
| Unannealed | 306 | 0.41 |
| stamp 6 | | |
| Aged | 372 | 0.11 |
| unannealed | | |
| stamp 1 | | |
| Aged | | 0.19123 |
| unannealed | | |
| stamp 2 | | |
| Aged | 133 | 0.11 |
| annealed | | |
| stamp 1 | | |
| Aged | 91 | 0.11 |
| annealed | | |
| stamp 2 | | |
| Cast CA | | |
| (NIFD) | | |

Example 1 FIG. 7: 1.25% CA

| | | |
|---|---|---|
| Annealed | 10 | 0.35 |
| stamp 1 | | |
| Unannealed | 13 | 0.43 |
| stamp 2 | | |

Example 1 FIG. 8: 2.5% CA

| | Brine | Li/Mg selectivity | Li permeance (GMH) |
|---|---|---|---|
| Stamp 1 | Unconcentrated lithium | 23 | 0.37 |
| | brine A | | |
| Stamp 2 | Unconcentrated lithium | 61 | 0.19 |
| | brine A | | |
| Stamp 3 | Unconcentrated lithium | 57 | 0.24 |
| | brine A | | |
| Stamp 1 | Unconcentrated lithium | 22 | 0.28 |
| | brine B | | |
| Stamp 1 | Concentrated lithium | 74 | 0.38 |
| | brine | | |

Example 2 FIG. 21: Cast CA

| | Li/Mg selectivity | Li permeance (GMH) |
|---|---|---|
| Stamp 1 | 217 | 0.03 |
| Stamp 2 | 750 | 0.11 |

### SCIENTIFIC LITERATURE REFERENCED

[1] X. Li, Y. Mo, W. Qing, S. Shao, C. Y. Tang, J. Li, Membrane-based technologies for lithium recovery from water lithium resources: A review, J. Membr. Sci. 591 (2019) 117317.https://doi.org/10.1016/j.memsci.2019.117317.
[2] J. R. Switzer, C. H. Cheng, S. R. Alferi, Purification of lithium-containing brine, US 2018/0353907 A1, n.d.
[3] Y. Li, Y. Zhao, H. Wang, M. Wang, The application of nanofiltration membrane for recovering lithium from salt lake brine, Desalination. 468 (2019) 114081. https://doi.org/10.1016/j.desa1.2019.114081.
[4] F. W. Altena, Phase separatio phenomenan in cellulose acetate solutions in relation to asymmetric membrane formation, University of Twente, 1982. https://ris.utwente.n1/ws/portalfiles/portal/6081068/1982_Altena.pdf (accessed May 10, 2019).
[5] A. J. Reuvers, F. W. Altena, C. A. Smolders, Demixing and gelation behavior of ternary cellulose acetate solutions, J. Polym. Sci. Part B Polym. Phys. 24 (1986) 793-804. https://doi.org/10.1002/polb.1986.090240406.
[6] A. C. Puleo, D. R. Paul, S. S. Kelley, The effect of degree of acetylation on gas sorption and transport behavior in cellulose acetate, J. Membr. Sci. 47 (1989) 301-332. https://doi.org/10.1016/S0376-7388(00)83083-5.
[7] K. D. Vos, F. O. Burris, R. L. Riley, Kinetic study of the hydrolysis of cellulose acetate in the pH range of 2-10, J. Appl. Polym. Sci. 10 (1966) 825-832. https://doi.org/10.1002/app.1966.070100515.
[8] S. B. McCray, V. L. Vilker, K. Nobe, Reverse osmosis cellulose acetate membranes. I. Rate of hydrolysis, J. Membr. Sci. 59 (1991) 305-316.https://doi.org/10.1016/S0376-7388(00)80819-4.
[9] C. E. Reid, E. J. Breton, Water and ion flow across cellulosic membranes, J. Appl. Polym. Sci. 1 (1959) 133-143.https://doi.org/10.1002/app.1959.070010202.
[10] S. Sourirajan, The science of reverse osmosis—Mechanisms, membranes, transport and applications, (n.d.) 23.
[11] N. T. Hancock, T. Y. Cath, Solute coupled diffusion in osmotically driven membrane processes., Environ. Sci. Technol. 43 (2009) 6769-75.
[12] T. D. Hodgson, Selective properties of cellulose acetate membranes towards ions in aqueous solutions, Desalination. 8 (1970) 99-138.https://doi.org/10.1016/S0011-9164(00)82017-2.
[13] T. S. Govindan, S. Sourirajan, Reverse Osmosis Separation of Some Inorganic Salts in Aqueous Solution Using Porous Cellulose Acetate Membranes, Ind. Eng. Chem. Process Des. Dev. 5 (1966) 422-429.https://doi.org/10.1021/i260020a014.
[14] M. E. Heyde, C. R. Peters, J. E. Anderson, Factors influencing reverse osmosis rejection of inorganic solutes from aqueous solution, J. Colloid Interface Sci. 50 (1975) 467-487. https://doi.org/10.1016/0021-9797(75)90170-8.
[15] J. Su, Q. Yang, J. F. Teo, T.-S. Chung, Cellulose acetate nanofiltration hollow fiber membranes for forward osmosis processes, J. Membr. Sci. 355 (2010) 36-44. https://doi.org/10.1016/j.memsci.2010.03.003.
[16] G. J. Irvine, S. Rajesh, M. Georgiadis, W. A. Phillip, Ion Selective Permeation Through Cellulose Acetate Membranes in Forward Osmosis, Environ. Sci. Technol. 47 (2013) 13745-13753.https://doi.org/10.1021/es403581t.
[17] H. Ohya, S. I. Semenovab, T. Fujimoto, J. Ogiharad, S. Fukaya, K. Mori, M. Aihara, Y. Negishi, Effect of electro-chemical properties of chloride salts on their diffusional parameters in symmetrical cellulose acetate membranes, (2001) 14.

We claim:

1. An ion selective membrane comprising an isotropic and nonporous polymer film, the film having a thickness in the range of 0.1 to 100 microns, a density in the range of 0.9 to 1.4, a T_{g} in the range of 25 to 450° C., and a Li/Mg selectivity in the range of 50 to 1000.

2. The ion selective membrane according to claim 1, wherein the film comprises a material selected from the group consisting of cellulose acetate, cellulose nitrate, and cellulose acetate butyrate.

3. The ion selective membrane according to claim 1, wherein the film comprises cellulose acetate having acetylation in the range of 30 to 45 wt %.

4. The ion selective membrane according to claim 1, wherein the film comprises a cellulose acetate selected from the group consisting of cellulose acetate ds 1.74, cellulose acetate ds 2.84, and cellulose acetate ds 2.45.

5. The ion selective membrane according to claim 1, wherein the film comprises cellulose acetate ds 2.45.

6. The ion selective membrane according to claim 1, wherein the film has a T_{g} in the range of 120 to 180° C.

7. The ion selective membrane according to claim 1, wherein the film has a water absorption capacity of approximately 1 to 40%,

8. The ion selective membrane according to claim 1, wherein the film is a single phase polymeric material.

9. The ion selective membrane according to claim 1, wherein the film is substantially free of MOF particles.

10. The ion selective membrane according to claim 1, wherein the film is substantially free of nanoparticles particles.

11. The ion selective membrane according to claim 1, wherein the film is disposed on a support surface.

12. The ion selective membrane according to claim 1, wherein the membrane has a Li/Mg ion selectivity in the range of from about 50 to about 800.

13. The ion selective membrane according to claim 1, the film having a crystallinity in the range of about 0 to about 5% by weight.

14. The ion selective membrane according to claim 1, wherein the membrane has a permeance in the range of from 0.1 GMH to about 2 GMH.

15. A method of use of the membrane of any one of claims 1-14, the method comprising using the membrane to separate a target ion from a non-target ion in a liquid medium.

16. The method of claim 15, comprising using the membrane for mineral separation, ion separation, water purification, energy conversion, or a combination thereof.

17. The method of claim 15, comprising using the membrane for the selective removal of Li from an aqueous solution.

18. The method of claim 15, comprising using the membrane for the selective removal of Li from a high salinity aqueous solution.

19. The method of claim 15, wherein the liquid medium has a variable ionic strength and the membrane does not lose selectivity as ionic strength increases.

20. The method of claim 15, comprising applying a potential bias to generate an electric field gradient that influences the flow of the target ion through the membrane to thereby separate the target ion from the non-target ion in the liquid medium.

21. The method of claim 15, wherein the target ion comprises Li⁺ and the non-target ion comprises Mg²⁺, Ca²⁺, SO₄²⁻, or a combination thereof.

22. The method of claim 15, wherein the target ion comprises Li⁺ and the non-target ion comprises Mg²⁺.

23. A system comprising the membrane of any one of claims 1-14 and a solution comprising a target ion and a non-target ion in a liquid medium, such that the target ion and the non-target ion are solvated.

24. The system of claim 23, wherein the target ion comprises Li⁺ and the non-target ion comprises Mg²⁺, Ca²⁺, SO₄²⁻, or a combination thereof.

25. The system of claim 23, wherein the target ion comprises Li⁺ and the non-target ion comprises Mg²⁺.

26. The system of claim 23, the system further comprising an electrode and a voltage source, wherein the voltage source and electrode are configured to apply a potential bias to generate an electric field gradient that influences the flow of the target ion through the membrane.

27. The system of claim 23, wherein the liquid medium has a variable ionic strength and the selectivity of the membrane remains substantially stable as ionic strength increases.
